(19) United States
(12) Patent Application Publication
(10) Pub. No.: US 2026/0358140 A1
(43) Pub. Date: Nov. 12, 2026

(54) Augmented Navigation During Takeoff and Landing

(71) Applicant: Supernal, LLC, Washington, DC (US)

(72) Inventors: Elena Ramona Stefanescu, Washington, DC (US); Matthew Phillip Aralis, Washington, DC (US)

(21) Appl. No.: 19/134,870

(22) PCT Filed: Dec. 7, 2023
(86) PCT No.: PCT/US2023/082989

§ 371 Date: Jun. 2, 2025

Related U.S. Application Data
(60) Provisional application No. 63/430,962, filed on Dec. 7, 2022.

(51) Int. Cl. G01C 23/00; G08G 5/20

(52) U.S. Cl. CPC G01C 23/005; G08G 5/20

(57) ABSTRACT

A method includes receiving, from at least two sources of information, information regarding a takeoff and landing area. The method also includes determining aircraft state information based on the information regarding the takeoff and landing area. The method additionally includes assigning one or more coefficients to the aircraft state information. The method further includes calculating one or more weighted aircraft state calculation values, where each of the one or more weighted aircraft state calculation values is associated with a coefficient of the one or more coefficients. The method also includes calculating an aircraft state of an aircraft that seeks to use the takeoff and landing area based on the one or more weighted aircraft state calculation values. The method further includes navigating the aircraft based on the calculated aircraft state of the aircraft.

### CROSS REFERENCE TO RELATED APPLICATION

This application claims priority to U.S. provisional Application No. 63/430,962, filed on Dec. 7, 2022, the contents of which are hereby incorporated by reference herein.

### BACKGROUND

An aircraft may land at a takeoff and landing area. The aircraft may be autonomous and/or partially or fully controlled by a human operator. Takeoff and landing areas may be located in a variety of locations and environments to facilitate a variety of activities, including for example, to transport passengers and/or objects, perhaps in an urban environment that includes a variety of buildings, businesses, homes, and other man-made structures. Takeoff and landing areas may be located in other environments such as terrain, body of water, forest, etc.

In some applications, it may be desirable to accurately determine takeoff and landing areas. Accurately determining takeoff and landing areas may facilitate precise control of takeoff and landing and safer takeoff and/or landing procedures.

### SUMMARY

The present disclosure describes implementations that relate to systems and methods for determining aircraft state information for navigation. The system may include various sensors among other components, which may be integrated in the aircraft as well as at the ground, building, vertiport, and/or landing level. A computing device may analyze the various sensor data to determine the aircraft state of an aircraft in the process of taking off or landing on a takeoff and landing area.

In a first example implementation, the present disclosure describes a system. The system may include a takeoff and landing area and an aircraft. The takeoff and landing area may include at least two sources of information, each of the sources of information being configured to provide information regarding the takeoff and landing area. The aircraft may include a computing system, the computing system configured to: receive, from the at least two sources of information, information regarding the takeoff and landing area; determine aircraft state information based on the information regarding the takeoff and landing area; assign one or more aircraft state to the aircraft state information; calculate one or more weighted aircraft state calculation values, wherein each of the one or more weighted aircraft state calculation values is associated with a coefficient of the one or more coefficients; calculate an aircraft state of an aircraft that seeks to use the takeoff and landing area based on the one or more weighted aircraft state calculation values; and navigate the aircraft based on the calculated aircraft state of the aircraft.

In a second example implementation, the present disclosure describes a method. The method includes receiving, from at least two sources of information, information regarding a takeoff and landing area. The method also includes determining aircraft state information based on the information regarding the takeoff and landing area. The method additionally includes assigning one or more coefficients to the aircraft state information. The method further includes calculating one or more weighted aircraft state calculation values, wherein each of the one or more weighted aircraft state calculation values is associated with a coefficient of the one or more coefficients. The method also includes calculating an aircraft state of an aircraft that seeks to use the takeoff and landing area based on the one or more weighted aircraft state calculation values; and navigate the aircraft based on the calculated aircraft state of the aircraft.

In a third example implementation, the present disclosure describes an aircraft. The aircraft may include at least one antenna configured to receive information regarding a takeoff and landing area from one or more sources of information and a computing system, the computing system configured to: receive, from the at least two sources of information, information regarding the takeoff and landing area; determine aircraft state information based on the sensor output containing information regarding the takeoff and landing area; assign one or more coefficients to the aircraft state information; calculate one or more weighted aircraft state calculation values, wherein each of the one or more weighted aircraft state calculation values is associated with a coefficient of the one or more coefficients; calculate an aircraft state of an aircraft that seeks to use the takeoff and landing area based on the one or more weighted aircraft state calculation values; and navigate the aircraft based on the calculated aircraft state of the aircraft.

In a fourth example implementation, the present disclosure describes a takeoff and landing area. The takeoff and landing area may include a first source of information configured to provide a first information regarding the takeoff and landing area; a second source of information configured to provide a second information regarding the takeoff and landing area; and a transceiver configured to transmit the first information and the second information to an aircraft seeking to utilize the takeoff and landing area, wherein the aircraft is configured to: receive the first and second sensor outputs; determine aircraft state information based on the first and second sensor outputs; assign one or more coefficients to the aircraft state information; calculate one or more weighted aircraft state calculation values, wherein each of the one or more weighted aircraft state calculation values is associated with a coefficient of the one or more coefficients; calculate an aircraft state of the aircraft based on the one or more weighted aircraft state calculation values; and navigate the aircraft based on the calculated aircraft state of the aircraft.

The foregoing summary is illustrative only and is not intended to be in any way limiting. In addition to the illustrative aspects, implementations, and features described above, further aspects, implementations, and features will become apparent by reference to the figures and the following detailed description.

### BRIEF DESCRIPTION OF THE FIGURES

FIG. 1 is a block diagram of an aircraft, in accordance with exemplary embodiments of the present invention.

FIG. 2 is a block diagram of a takeoff and landing area, in accordance with exemplary embodiments of the present invention.

FIG. 3 is a block diagram of a method, in accordance with exemplary embodiments of the present invention.

FIG. 4 illustrates a fiducial marker system, in accordance with exemplary embodiments of the present invention.

FIG. 5 illustrates sensor fields of view, in accordance with exemplary embodiments of the present invention.

FIG. 6 is a flowchart of a method, in accordance with exemplary embodiments of the present invention.

### DETAILED DESCRIPTION

Disclosed herein are systems and methods involving at least two sensors and various calculation modules to estimate an aircraft state of an aircraft. The system may also include various other components. Further, the system may be integrated into any system that has use for determining aircraft state information, including but not limited to, a takeoff and landing area for an aircraft, an aircraft itself, and an independent localization system, among other examples.

The system may use an interactive multiple model approach. In the interactive multiple model approach, the system may integrate various sensors and markers and use weighted data from the various sensors. The interactive multiple model system may run one or more model-matched state estimations in parallel. The state estimation filters may exchange information (e.g., interact) at each sampling time. A model probability evaluator calculates the current probability of the vehicle being in each of the possible modes. A global estimate of the vehicle's state may be computed using the latest mode probabilities. This algorithm may carry out soft-switching between the various modes by adjusting the probabilities of each mode, which may be used as weightings in the combined global state estimate. The covariance matrix associated with this combined estimate may take into account the covariance of the mode-conditioned estimates as well as the differences between these estimates. Such a system may improve accuracy and fidelity over alternative systems that use a limited number of sensors and vote between the sensors and/or weigh the sensor data to determine which data is accurate (e.g., a system using three sensor voting). Under the multiple model approach, the system may integrate measurements from various systems and sensors, including but not limited to, an inertial navigation system (INS), global navigation satellite system (GNSS), a real-time kinematic (RTK) positioning system, optical sensors (e.g., a camera, LiDAR sensors), high resolution radar, pseudolites, radio frequency (RF) beacons, and infrared (IR) beacons, among other examples. The system may then fuse the measurements from these sensors to refine conclusions based on sensor values and smoothly transfer between using a set of sensors to another set of sensors.

The takeoff and landing portion of an aircraft's flight path may often be the most accident-prone portion of the flight path. This potential hazard coupled with the time and resources used to train a (remote) pilot may make it desirable to have a vehicle with autonomous navigation features. The navigation and guidance services for vehicle operations may use a combination of currently available and new technologies to guide aircraft from takeoff through landing. Sensors with complimentary modalities and error characteristics may be deployed to improve navigation accuracy.

Technologies for precision landing used in general aviation are generally not based on GNSS (e.g., the Instrument Landing System (ILS), or Microwave Landing System (MLS)). These technologies cannot easily be adapted to VTOLs due to their cost, size, and weight of the onboard equipment and ground equipment. For example, microwave landing systems may be used on helipads, but the space on the ground for the microwave equipment may be unrealistic for urban environments and/or small vehicle landing areas. Hence, a navigation technique for precision takeoff and landing for vehicle operations may have the following properties: capability for autonomous navigation, obstacle-free landing area, capability for nighttime and severe weather conditions like fog, rain, and dust, and a robust and redundant setup.

In particular, for availability/reliability, the aircraft may need above a threshold high amount of availability due to low range in a battery used to power the aircraft. For precision, the aircraft may need above a threshold high limit of precision, depending on the height at which the aircraft is operating. For example, if the aircraft is operating above a threshold height, the aircraft may use a lower limit for precision. Whereas, if the aircraft is operating below a threshold height, the aircraft may use a higher limit for precision. Aircraft data may also have various update rates, perhaps depending on the situation (e.g., the height of the aircraft).

Various sensors, markers, receivers, and beacons may be used to facilitate determining an aircraft state of the aircraft respective to the takeoff and landing area, including GNSS and other internal navigation system technologies, vision based takeoff and landing, landmark based navigation, visual fiducial markings, infrared beacons, radar based, radio frequency beacons, LiDAR, ultra-wideband (UWB) multilateration techniques, perception-based navigation systems, angle of arrival measurement with an electronically scanned array, and/or 5G receivers, among other examples.

As used herein, an “aircraft state” of an aircraft may include orientation, position, altitude, velocity, and/or acceleration, among other information. The aircraft state of the aircraft may be expressed as or otherwise include a vector of states. In particular, the aircraft state may include a vector that contains 3D position (perhaps including altitude), velocity, altitudes, and orientation, where one or more of these values may be expressed with respect to a local or global frame. In some embodiments, the aircraft state of the aircraft may be relative to a takeoff and landing area.

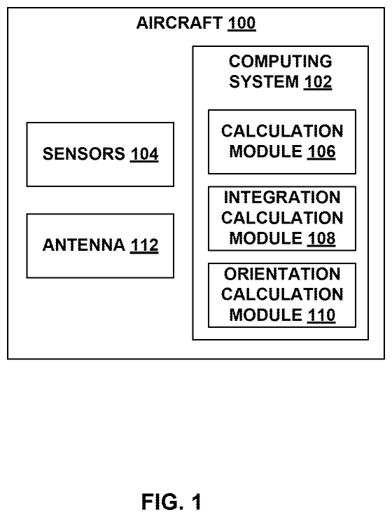

FIG. 1 is a block diagram of an aircraft, in accordance with exemplary embodiments of the present invention. As an example, the aircraft 100 may be a vertical takeoff and landing (VTOL) vehicle. Further, in some embodiments, the aircraft 100 may use electric power to hover, takeoff, and/or land vertically. The aircraft 100 may include components that facilitate movement, including one or more gearboxes that each drive one or more propellers and/or one or more propeller motors. The aircraft 100 may also include multiple lift rotors that facilitate vertical takeoff and landing of the aircraft 100. Each lift motor may be driven by a gearbox, which in turn may be driven by an electric motor. Further, the aircraft 100 may have one or more battery modules and one or more energy management systems (EMSs) that are in communication with the battery modules and that are configured as electronic regulators to monitor and control the charging and discharging of the battery modules.

As shown in FIG. 1, the aircraft 100 may include one or more additional and/or alternative components, including but not limited to a computing system 102, a sensors 104, and an antenna 112. The computing system 102 may include calculation module 106, calculation module 108, and aircraft state calculation module 110.

As used herein, “sources of information” may refer to the sensors 104, among other sources of information. Furthermore, any action discussed herein as being performed by or involving a “source of information” can be performed by or involve one or more of the sensors 104.

The sensors 104 may include various sensors and/or various sensor systems. For example, sensors 104 may include an INS, GNSS, and RTK systems, where each system may have one or more sensors and send one or more measurements to a computing system of the aircraft 100. Using a combination of these sensors may help negate the impact of potential impediments to accurately determine an aircraft state, including limited satellite visibility, the multipath effect, interference, and foliage attenuation, among other examples.

Further, the sensors 104 may include optical sensors, which the aircraft 100 may use to help facilitate continuous fusion between the various sensors and navigation. Optical sensors may include cameras, and LiDAR sensors, among others. Aircraft 100 may use the optical sensors to identify features, markers, and/or other landmarks on the takeoff and landing area to determine the aircraft state of the aircraft 100.

In particular, the aircraft 100 may include a LiDAR sensor, and the aircraft 100 may analyze data from the LiDAR sensor 104 to determine where the aircraft 100 is located in the environment and/or which orientation the aircraft 100 is facing. For example, the aircraft 100 may use a LiDAR sensor to capture successive frames of point cloud data. The aircraft 100 may then compare the successive frames of point cloud data to determine the relative motion of the aircraft and generate odometry measurements. To compare the success frames of point cloud data, aircraft 100 may use an iterative closest point (ICP) algorithm or other distance minimization algorithm.

In some examples, the LiDAR sensor may be a solid-state LiDAR sensor, which may be a sensor based on a silicon chip and may not have mechanically moving parts. The benefits of the solid-state construction are reflected in reduced construction space, allowing suppliers to cut costs and reach small dimensions so that the units can be integrated into aircraft. Because solid-state LiDAR sensors have no moving parts, the sensor could also be resistant to shock and vibration and thus is less prone to motion-related inaccuracy. Solid-state LiDAR may also have the capability to provide accurate 3D imaging in any weather, independent of day or night. Such capabilities are possible thanks to a concept similar to phased-array radar, in which several optical emitters send out bursts of photons in specific patterns and phases to create a directional emission. The size, focus, and direction of this broadcast can be changed without having to physically adjust the transmitters.

While navigating in areas where 3D building models are available, aircraft 100 may load and preprocess the 3D building models into the urban building map to provide an alternative way to anchor the landing positions to the global frame. Prior to urban navigation, aircraft 100 may first initializes the urban building map with the intended navigation area by pre-loading existing 3D LiDAR building model data. At each measurement epoch, the LiDAR sensor may generate a 3D point cloud of its surrounding environment in its own LiDAR frame. By comparing consecutively collected point clouds and applying the iterative closest point (ICP) algorithm, a computing device can derive the relative motion of the aircraft and generate odometry measurements. Given a source and a reference point cloud, the ICP algorithm may seek to determine a translation and rotation transformation that would best match the two input clouds by minimizing the correspondence residual function.

Navigating at low altitudes, the aircraft 100 may extract the outline from each building to be compared with the observations seen from each LiDAR point cloud. To identify comparable features between the urban building map and the LiDAR point clouds, LiDAR plane-fitting may be used to extract walls and large recognizable features from the LiDAR point cloud. This may be accomplished with the M-estimator sample consensus (MSAC) algorithm, a variant of the random sample consensus (RANSAC) algorithm.

Sensors 104 may also include pseudolites, electronically scanned arrays, 5G receivers, and other technologies that can send and/or receive data. Pseudolites may facilitate the localization of the VTOL aircraft. Electronically scanned arrays may help facilitate determination of the angle of arrival, and 5G receivers may help determine an aircraft state.

For example, a pseudolite is a pseudo-satellite, typically a ground-based system, which functions as a navigation satellite. A network of pseudolites located at the perimeter of a takeoff and landing area could be used for the final phase of the approach very close to the touchdown point when geometry becomes favorable. A pseudolite may be a transceiver, which may be used to help facilitate localization of the VTOL aircraft. The range of the signal for the pseudolite may depend on the power available to the unit. A system such as Locata, which uses beamforming antennas to mitigate multipath, and synchronization of time among pseudolites to one nanosecond RMS, has been deployed for close range applications, such as drilling in deep mines and autonomous container transport in ports.

Electronically scanned arrays (ESA) may also be used to help facilitate determining an aircraft state. ESAs are becoming more affordable driven primarily by progress in 5G technology. ESA can be used on the aircraft to measure angle of arrival from an RF beacon. It can also be used on the ground to determine azimuth and elevation of an aircraft transponder. These measurements could be sent to an aircraft via a dedicated datalink. That datalink can also be used to measure range to the aircraft.

5G technologies may also be used to help facilitate determining an aircraft state. The rollout of 5G cellular services offers another path for a backup navigation source in case of loss of GNSS, particularly at higher altitudes. 5G architectures include base stations with directional antennas at Ka Band or higher. These high bandwidth links could provide accurate ranging, with inherent multipath resistance, and could also measure angle of arrival (AZ/EL) measurements to the aircraft. As with wideband LEO, if these types of services could be delivered in conjunction with core data communications, then significant savings in size, weight, power, and cost could be achieved.

Additional sensor examples and/or configurations are provided below in the context of a takeoff and landing area. In some examples, the sensors of the takeoff and landing area may be integrated into aircraft 100, such that the aircraft 100 may collect sensor data of the takeoff and landing area from its location in the environment. The aircraft 100 may then send the data to the takeoff and landing area, where a computing system of the takeoff and landing area may aggregate and analyze the data to determine an aircraft state of the aircraft 100.

The computing system 102 may be configured to receive and analyze data from the sensors. In particular, the computing system 102 may carry out the operations of the calculation module 106, the integration calculation module 108, and the aircraft state calculation module 110. The calculation module 106 may be associated with each of the sensors 104, and the calculation module 106 may be configured to receive sensor output from its associated sensor and utilize the sensor output to calculate aircraft state information.

The integration calculation module 108 may be configured to carry out various operations with the information received from the calculation module 106. For example, the integration calculation module 108 may receive aircraft state information from the calculation module 106, assign a coefficient to the aircraft state information, and output a weighted aircraft state calculation value associated with the calculation module 106.

Next, the aircraft state calculation module 110 may be configured to receive the weighted aircraft state calculation values from the integration calculation module 108. Based on the received weighted aircraft state calculation values, the aircraft state calculation module 110 may be configured to calculate an aircraft state of the aircraft that seeks to use takeoff and landing areas in the environment.

The computing system 102 may be connected to and/or receive data from one or more the sensors 104. In some examples, the computing system 102 may include one or more calculation modules 106, one or more integration calculation modules 108, and/or one or more aircraft state calculation modules 110, such that each module is associated with a sensor. For example, each calculation module 106 may be associated with a sensor, and each integration calculation module 108 may be associated with a calculation module 106.

The computing system 102 may include one or more processors. A processor can include a general purpose processor (e.g., a single core microprocessor or a multicore microprocessor), or a special purpose processor (e.g., a digital signal processor, a graphics processor, or an application specific integrated circuit (ASIC) processor). A processor can be configured to execute computer-readable program instructions (CRPI) to perform the operations described throughout herein. A processor can be configured to execute hard-coded functionality in addition to or as an alternative to software-coded functionality (e.g., via CRPI).

In some embodiments, the calculation module 106, the integration calculation module 108, and/or the aircraft state calculation module 110 may be hardware and/or software. For instance, in some embodiments, the calculation module 106, the integration calculation module 108, and/or the aircraft state calculation module 110 may be a segment or portion of program code, which includes one or more instructions executable by a processor. The program code may be stored on any type of computer readable medium or memory, for example, such as a storage device including a disk or hard drive.

The computer readable medium may include a non-transitory computer readable medium or memory, for example, such as computer-readable media that stores data for short periods of time like register memory, processor cache and Random Access Memory (RAM). The computer readable medium may also include non-transitory media or memory, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, a tangible storage device, or other article of manufacture, for example.

Next, the aircraft 100 may include the antenna 112. The antenna 112 may be configured to receive and/or transmit signals, perhaps also to facilitate communication to and from a takeoff and landing area and/or to and from another aircraft. The antenna 112 may include one or more antennas, where each antenna is configured to receive signals of a particular wavelength.

For example, the antenna 112 may include one or more antennas that may facilitate radar-based takeoff and landing. The antenna 218 may include millimeter wave (mmWave) radar sensors, which may be small, lightweight, and based on the Frequency Modulated Continuous Wave (FMCW) principle. A chirp with increasing frequency is transmitted whereas the frequency difference between the transmitted and received signal is proportional to the distance. Transmitting a whole radar frame consisting of many chirps also may allow the computing system to estimate the relative velocity via the Doppler shift. In contrast to traditional FMCW radars, which have only a single transmitter (Tx) and receiver (Rx) antenna, multiple Tx and Rx antennas may be used. Consequently, the azimuth and elevation angle of each detected object can be estimated as well.

Targets may be detected using a Constant False Alarm Rate (CFAR) detector. Accurate Angle of Arrival (AoA) estimation typically requires a large aperture. Large virtual antenna arrays may be built by combining multiple transmitter and receiver antennas. The FMCW configuration may be based on velocity and angle resolution, among other factors. These do not describe the accuracy but the ability to distinguish targets. If the same range is measured for more than one target, separating the targets may still be possible if either the velocity difference or the AoA difference is large enough. If the velocity and AoA are the same for multiple targets, separation may still be possible if the range difference is large enough. The accuracy of the measurement may be determined by the size of the different Fast Fourier Transformation (FFTs) resulting in respective bin sizes.

The detection of the takeoff and landing area may consist of several steps of filtering and geometric matching. For example, a computing system may determine the Radar Cross Section (RCS) of each target using the provided peak value. Since the RCS of each radar reflector is known, association could be carried out quite easily. The pose estimation is based on radar reflector detection with corresponding coordinate system using various techniques for multilateration.

With regards to radio frequency beacons, a receiver inside an aircraft, e.g., the antenna 112 of the aircraft 100, can measure angle of arrival for a signal emitted by a radio frequency beacon. Accuracy of the angle of arrival measurement may depend on the signal frequency, aircraft antenna size, and RF multipath environment. In a low multipath environment, with an electronically steered antenna array sized for the aircraft, and with an appropriate radio frequency choice it may be possible to achieve accuracy of single digit milliradians Root Mean Square (RMS).

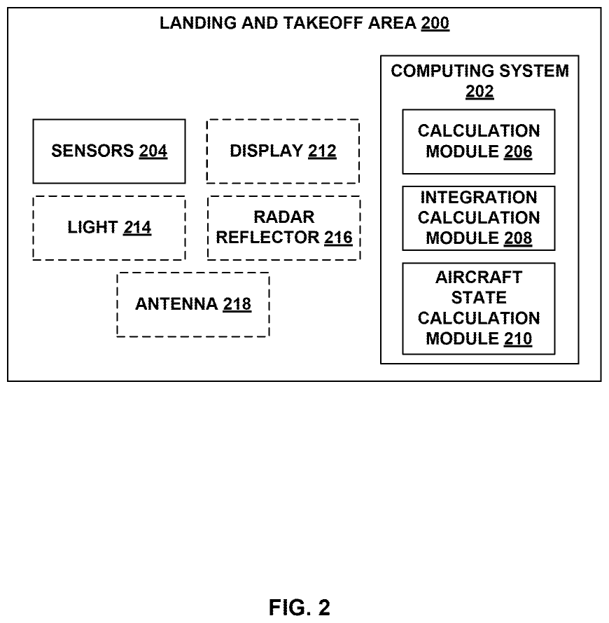

FIG. 2 is a block diagram of a takeoff and landing area, in accordance with exemplary embodiments of the present invention. The takeoff and landing area 200 may include a computing system 202, sensors 204, a display 212, a light 214, a radar reflector 216, an antenna 218, among other examples.

The computing system 202 may include a calculation module 206, a integration calculation module 208, and an aircraft state calculation module 210. The calculation module 206, the integration calculation module 208, and the aircraft state calculation module 210 may carry out various operations similar to the calculation module 106, the integration calculation module 108, and the aircraft state calculation module 110 of FIG. 1.

The sensors 204 may include sensors described with respect to sensors 104 of FIG. 1, including but not limited to INS, GNSS, and RTK systems as well as camera and LiDAR sensors.

For example, a GNSS system may have a sensor output that provides a source of high-accuracy all-weather meter-level absolute positioning with global coverage that does not require expensive investment in systems for map production, storage, maintenance, and dissemination.

As used herein, “sources of information” may refer to the sensors 204, the light 214, the antenna 218, the display 212, or the radar reflector 216, among other sources of information. Furthermore, any action discussed herein as being performed by or involving a “source of information” can be performed by or involve one or more of the sensors 204, the light 214, the antenna 218, the display 212, or the radar reflector 216.

However, solely relying on GNSS-navigation may lead to multiple safety and availability limitations. Due to errors caused by multipath scattering or shading of the GNSS signal, position accuracy can degrade significantly. In addition, spoofing can result in a fake localization and jamming even in a complete GNSS loss. Thus, GNSS only navigation cannot be safely used in areas where these kinds of errors occur. This is the case in particular close to landing areas since these are typically located in urban environments or at ground level. Therefore, precision takeoff and landing based on GNSS may not yield a safe and reliable flight operation.

Carrier-phase-differential GNSS positioning, such as RTK or Precise Point Positioning (PPP) can meet the most demanding accuracy requirements envisioned for various vehicles, but has historically been either too fragile, except in open areas with a clear view of overhead satellites, or too expensive, for widespread adoption. At more sophisticated airports, helicopters can take advantage of precision navigation aiding system if they are capable of ILS approaches. ILS, in combination with high-intensity lighting arrays, may allow for safe landing of IFR capable aircraft during IMC. Ground-Based Augmentation System (GBAS) is an alternative to ILS. GBAS may have multiple advantages over ILS, including simplified airport infrastructure, steadier approach guidance, and fewer flight inspections.

Therefore, to bridge the availability gaps of GNSS in urban environments and at the takeoff and landing area level, the takeoff and landing area 200 may include an inertial navigation system (INS) as one of the sensors 204, and the computing system 202 may incorporate measurements from the INS to determine an aircraft state. Inertial measurements may be uniquely valuable due to their invulnerability to environmental effects such as weather and radio interference. Combined GNSS and inertial navigation systems can be termed loosely coupled if they incorporate GNSS position solutions as measurements for a downstream navigation filter. By contrast, tightly coupled systems may directly incorporate raw GNSS observables (pseudorange, Doppler, or carrier phase) as measurements. While both loosely- and tightly-coupled aiding can bridge availability gaps, tightly-coupled aiding can additionally reduce these gaps' incidence and duration: the probabilistic constraint between GNSS measurement epochs provided by the inertial sensor can increase the success rate of carrier phase integer ambiguity resolution and make the navigation solution observable with fewer GNSS measurements.

The sensors 204 may also incorporate a terrestrial navigation system, which may be a radio-based system that may behave similarly to GNSS except that (i) the transmitters are ground-based, (ii) the signals can be wide-band, and/or (iii) the signals can be predetermined for both positioning (ranging) and telecommunications.

The takeoff and landing area 200 may also include LiDAR sensors, which may aid takeoff and landing of an aircraft. LiDAR sensing may provide high resolution environment data by sending out thousands of laser signals. These lasers may bounce off objects, returning to the sensor where the computing system 202 can then determine how far away objects are by timing how long it takes for the signal to return. In addition, the computing system 202 may gather information on the objects in the environment (e.g., the material of the object) by measuring the intensity of the returned signal. Each laser ray may be in the infrared spectrum, and a computing system may send the signals out at many different angles, usually in a 360-degree range, resulting in a very high accurate/dense models for the environment in 3D.

The takeoff and landing area 200 may also include a display 212. The display 212 may include one or more markers which may facilitate locating the aircraft. For example, vision based takeoff and landing may incorporate various sensors and/or markers, as accurate localization is important for the autonomous navigation of aircrafts in takeoff and landing situations.

Takeoff and landing of an aircraft, e.g., the aircraft 100, may be based on unique markers at the takeoff and landing area 200. In particular, vertical takeoff and landing may be facilitated by vision based-navigation using unique markers and inertial measurements to determine where to hover at takeoff to hover and where hover for landing. For such a vision-based navigation system, the number, type, and location of cameras onboard the aircraft may be chosen to ensure that the vision-based system meets the integrity and continuity requirements for the primary system.

Vision based navigation systems for takeoff and landing navigation can be used in the context of two main applications: landmark based navigation and fiducial markers navigation.

With regards to landmark based navigation, probabilistic localization approaches may be applied in in both structured and unstructured environments, which may enable the successful deployment of autonomous aircrafts using either a grid-based representation of the environment or a landmark-based map. The landmark maps usually may contain sets of independent 2D or 3D points representing distinct and recognizable objects, or bounding boxes around objects at the takeoff and landing area level, such as buildings, radio masts, trees, stadium etc.

Storing objects in a landmark-based map may need a small amount of memory compared to a grid-based map, where the area is discretized into small cells (e.g., voxel maps). Moreover, landmark-based maps may be easier to maintain and update since landmarks can be added or removed without much effort. The computing system may build maps of the environment offline. The computing system may go through multiple iterations of maps to determine with an accurate representative map. During online localization, the aircraft extracts landmarks using on-board sensors that may be matched with the map landmarks and, eventually, estimating the aircraft's pose. Fusion with an inertial navigation system (INS) may be needed to improve localization accuracy.

With regards to fiducial markers navigation, a visual fiducial marker may be a known shape usually located in the environment as a point of reference and scale for a visual task. Fiducial markers may have a highly distinguishable pattern with strong visual characteristics that also feature specific encoding as a fail-safe against misdetections. These artificial landmarks of known size and shape that feature a specific pattern may be relatively easy to identify. The fiducial markers may be in black and white. Additionally and/or alternatively, the markers may be colored. Although colored markers may have advantages (e.g., decreased detection time and false positives), they may not be very robust when the marker is farther away and/or at a steep angle relative to the aircraft.

Visual fiducial markers may be passive markers (e.g., their shape, size and scale remain unchanged over time) or dynamic markers (e.g., adapt over time to the requirements of the perception process).

The vision-based autonomous landing of VTOL aerial vehicles may rely on passive fiducial markers at takeoff and landing area level. The landing point may be defined using a marker that can be detected by a downward looking camera in the VTOL and further tracked for landing. Complex fiducial markers may allow the extraction of more information, for example, full 3D pose and identification of the marker between a large library of possible markers. Additionally, the number of features used for pose calculation may improve the accuracy of the calculated pose.

Some examples of passive fiducial markers include ARTag, AprilTag, ArUco, Rune Tag and ChromaTag, any of which may be integrated into the display 212.

For piloted aircrafts during visual flight operations, Federal Aviation Administration has recently released an Engineering Brief that recommends a broken wheel symbol to be placed in the center of the takeoff and landing area. However, the sign which was chosen after research done in 1967 has not been adapted for autonomous takeoff and landing. Its symmetric design can cause, without additional information, high orientation and scale uncertainty.

To avoid this issue, the takeoff and landing area 200 may include one or more fiducial markers by way of the display 212. The maximum range of fiducial marker detection may be relevant for autonomous takeoff and landing. When the aircraft is farther away, a large marker may be advantageous to increase detection difference. However, when the aircraft approaches the marker, then the marker may be too big for the camera to detect. Hence, it may desirable to have a marker that can change its shape, size and scale with the distance and orientation of the aircraft as is approaching landing or takeoff. One way of creating this type of dynamic fiducial markers can be done either using some type of smart paint (e.g., LumiLor) or using a screen (such as LED/LCD displays, or E-Ink displays) that can change the marker shape dynamically. Fiducial markers provide a computational efficient way for the aircraft to determine its position with respect to the touchdown and liftoff area.

While the fiducial markers presented above may be detected using visible spectrum cameras for VFR operation, for low lighting (e.g., night, dawn, dusk) or inclement weather conditions, IR cameras in near infrared (NWIR)/long wave infrared (LWIR) spectrum may be used. Such fiducials could be designed using optical coatings.

In addition, the display and/or any markers may incorporate processes using plasma-enhanced chemical vapor deposition and/or ion assist deposition with electron beam sputtering and resistance sources. These coatings may facilitate the detection of the markers.

The takeoff and landing area 200 may also include a light 214. The light 214 may include one or more light sources, perhaps arranged in a particular pattern that may facilitate determining an aircraft state. In some examples, the configuration of lights 214 of the takeoff and landing area 200 may include an identification beacon, which may flash white, yellow, and/or green lights at a rate of 30 to 45 flashes per minute.

Lighting may be needed for takeoff and landing areas that support night operations. For pilot-on-board aircraft, the lighting may enable the pilot to both establish the location of the takeoff and landing areas and identify the perimeter of the operational area. For autonomous aircrafts, the lighting may facilitate the localization of the aircraft relative to the takeoff and landing area. IR LED and blue LED placed on takeoff and landing area and final approach and takeoff (FATO) area may be non-uniformly separated, in a pattern that can increase the accuracy and robustness of a localization system by providing an easily recognizable sign with embedded fault detection.

The configuration of lights 214 at the landing and takeoff area 200 may be based on the shape of the takeoff and landing area 200. The takeoff and landing area 200 may be various shapes, including circular, rectangular, and square. If the takeoff and landing area 200 is square, then the takeoff and landing area 200 may include one light at each corner, lights evenly distributed along the sides with at least five lights on each side, lights spaced less than or equal to 25 feet apart, and lights along the approach path. If the takeoff and landing area 200 is circular, then the takeoff and landing area 200 may include an even number of lights, at least eight lights that are evenly distributed along the parameter, and lights less than one foot inside or outside of the parameter line.

The takeoff and landing area 200 may also include a radar reflector 216. The radar reflector 216 may reflect radar signals. Radar reflectors may be multiple scatterers, dielectric lenses, and retrodirective arrays. Multiple scatterers may take the form of corner reflectors. In some examples, the corner reflectors may be square trihedral corner reflectors, triangular trihedral corner reflector, and circular trihedral corner reflectors. These reflectors may be installed at the touchdown and lift off area (TLOF) level of a vertiport, for example.

The takeoff and landing area 200 may also include an antenna 218. The antenna 218 may be configured to receive and/or transmit signals, perhaps also to facilitate communication to and from a takeoff and landing area and/or to and from another aircraft. The antenna 218 may include one or more antennas, where each antenna is configured to receive signals of a particular wavelength. In some embodiments, the takeoff and landing area 200 may include a transceiver configured to transmit signals. Further, in some embodiments, the antenna 218 may include the transceiver. Moreover, in some embodiments, a transceiver may include a receiver and a transmitter.

For example, a directional antenna could be used at the takeoff and landing area for multipath mitigation. The aircraft could use configurable reception pattern antenna to provide beam steering, which may provide very effective multipath mitigation.

The computing system may also use UWB multilateration to determine aircraft state information of the aircraft. Many microwave-based wireless local positioning systems (WLPS) may also be based on the time-of-arrival (TOA) or time-difference-of-arrival (TDOA) measurement principles. Such systems in general consist of multiple static devices at known positions distributed across the measurement area (instead of satellites in space). The Locata system is another example of a WLPS designed to enable localization at places where GPS is not available. Using a network of time synchronized transmitters (e.g., pseudolites) and GNSS-similar localization principles it may have the ability to achieve accuracies in the range of 1-10 cm by also utilizing the carrier phase.

As the range estimation accuracy and resolution is in general proportional to the signal bandwidth, multiple localization systems based on UWB signals have been proposed and several have made it to commercial products. UWB is defined as any radio with bandwidth spectrum at least 500 MHz or 25% of center frequency. Narrow band technologies, on the other hand, may have bandwidth of 10% of center frequency or less. UWB radio networks are low-power, simple, and easily deployable local systems that may be used for navigation and positioning purposes. The properties of the UWB signal are attractive because they can go through obstacles, providing potential positioning in environments where other systems are not suitable. Some UWB features include (1) High data rate, up to 2 Mbps; (2) High density of devices; (3) Low susceptibility to multipath fading; (4) High immunity against wireless networks interference; (5) Secure communication.

A UWB transmission may use time-division multiple access (TDMA) to communicate between anchor nodes. The anchor nodes may be included in antenna 218 A UWB tag may send a periodic data request to all anchors within its range. The tag measures response time (TOA/TDOA) and is able to determine distance to each anchor. When the anchor position is known, the tag location is inferred easily. UWB systems can achieve very good accuracy, since the range resolution is in general proportional to the bandwidth. The accuracy of UWB localization, however, strongly depends on the geometric distribution of the anchors. Also, due to the relatively low power of UWB systems, their maximum measurement range is in general limited to a few tens of meters.

While multilateration allows for precise localization by only using relatively simple range-measuring sensors, it may have some drawbacks. Multiple anchor nodes may be needed to determine the target position. Hence, complex infrastructure may be needed and there is high installation and maintenance cost and effort if a large area needs to be covered. Furthermore, this leads to lower reliability, as multiple measurements of different units may be needed to obtain a single estimate for the target position. This means that if the measurement to one of the static anchors fails, e.g., due to missing line-of-sight (LOS) or due to multipath fading, no positioning may be performed. This problem may be mitigated by carefully choosing the static anchors' positions or by simply increasing their number. This is already being done in GPS-based positioning systems by incorporating the satellites of other GNSS systems to increase the reliability e.g., in urban canyons.

Additionally and/or alternatively, localization may be based on the combination of the Round-Trip Time of Flight (RTOF) and the direction-of-arrival (DOA) measurement principles. This means that only a single static anchor node and a single measurement is sufficient for a 2D or 3D position estimate. This system concept may reduce the number of static anchor nodes (and thus the system cost) and increases its robustness.

In some examples, the takeoff and landing area 200 may be associated with one or more dimensions of an aircraft that takes off and lands at the takeoff and landing area 200. For example, the smallest circle that can enclose an aircraft that takes off from and lands at the takeoff and landing area 200 may have a diameter of D, and the associated takeoff and landing area 200 may have dimensions of D by D. At least one fiducial marker may also be associated with the landing and takeoff area 200 and the at least one fiducial marker may fit in the dimensions of the takeoff and landing area 200. In some examples, the takeoff and landing area 200 may have a minimum dimension of D by D but may be configured to have dimensions greater than D by D. In further examples, the takeoff and landing area 200 may be circular, rectangular, or square in shape, but may have a minimum dimension of being D in diameter, D by D in length and width, or D by D in length and width, respectively.

Further, the takeoff and landing area 200 may be in the middle of a final approach and takeoff area. The final approach and takeoff area may have twice the length and twice the width of the takeoff and landing area, thereby having dimensions of 2D by 2D if the takeoff and landing area 200 has dimensions D by D. In some examples, the final approach and takeoff area may be surrounded by a safety area with a particular dimension (e.g., ½ D all around, if the takeoff and landing area has dimensions of D by D). The takeoff and landing area 200 may have materials of either concrete or metal. If the surface material is conductive, the surface may be grounded to avoid damage in case of short circuits and/or lightning strike. The surface may also have a roughened pavement finish so that the aircraft and/or people walking on the takeoff and landing area 200 are less likely to slip.

The takeoff and landing area 200 may be located, for example, at ground level (on terrain or on a level platform), on an elevated structure, or at rooftop level. In addition, the takeoff and landing area may be integrated into an airport intended to support takeoff and landing of a non-vertical takeoff and landing aircraft (e.g., airplanes and helicopters).

As mentioned, the takeoff and landing area 200 may include markings, lighting, and visual aids to help guide and orient an aircraft utilizing the takeoff and landing area 200 as well as to keep the area surrounding the takeoff and landing area 200 safe. Such markings and visual aids may include, for example, painted or preformed materials, reflective paint and retroreflective markers, outlining markings and lines, perimeter markings, size/weight limitation markings, and identification markings or symbols denoting the takeoff and landing area 200. The lighting may include omnidirectional perimeter lighting (general lighting as well as lights to illustrate the corner or edges of the takeoff and landing area 200), elevated lighting, lighting within the surface of the takeoff and landing area 200, flight path alignment lighting (such as approach lights), visual glideslope indicators (VGSI), floodlights, and/or identification beacon(s). The takeoff and landing area 200 may also include safety netting and/or additional safety features, particularly for elevated or raised takeoff and landing areas. The takeoff and landing area 200 may also include additional infrastructure/technology/services known to those skilled in the art, such as infrastructure/technology/services for sensing the weather, providing safety and security, providing electric charging or fueling capabilities, providing firefighting or medical capabilities, and providing access to those with disabilities.

Further, the takeoff and landing area 200 may have markers (e.g., the takeoff and landing area size and weight limitation box) indicating the size and weight limitations of the takeoff and landing area. The takeoff and landing area size and weight limitation box may include numbers against a black background, the maximum weight of an aircraft landing on the takeoff and landing area, among other symbols.

One or more components of the takeoff and landing area 200 may be incorporated into the aircraft 100, and/or one or more components of the aircraft 100 may be incorporated into the takeoff and landing area 200. The takeoff and landing area 200 and aircraft 100 may communicate with each other, perhaps through the antenna 218 of the takeoff and landing area 200 and/or through the antenna 112 of the aircraft 100, to aggregate data and determine an aircraft state of aircraft 100.

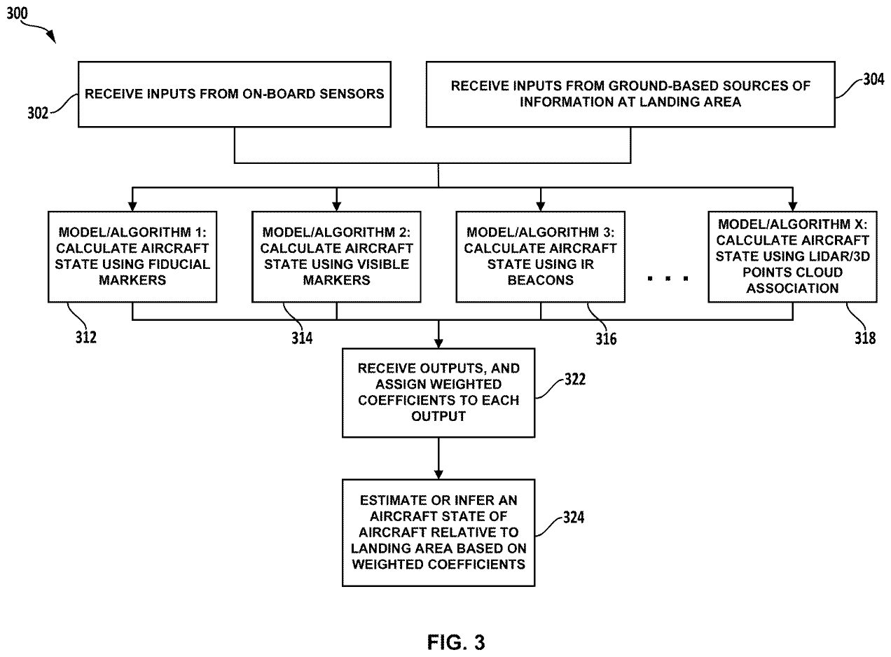

For example, FIG. 3 is a block diagram of a method, in accordance with exemplary embodiments of the present invention. A method 300 may be carried out by the aircraft 100 and/or the takeoff and landing area 200.

At a step 302, the method 300 includes receiving inputs from on-board sensors. For example, the computing system 102 of aircraft 100 may receive sensor data from the sensors 104.

At a step 304, the method 300 includes receiving inputs from ground-based sensors and markers at the landing area. For example, the computing system 202 of the takeoff and landing area 200 may receive sensor data from the sensors 204.

Receiving inputs from on-board sensors receiving inputs from ground-based sensors and markers at the landing area may be carried out alone or in conjunction. For example, the computing system 202 of the takeoff and landing area 200 may locate the aircraft 100 based on receiving sensor data from the sensors 204. Additionally and/or alternatively, the aircraft 100 may collect sensor data from the sensors 104 and transmit the data (perhaps by way of the antenna 112) to the takeoff and landing area 200, where the takeoff and landing area 200 may locate the aircraft 100 based on the sensor data alone or in conjunction with sensor data collected by the sensors 104. Further, the aircraft 100 may carry out receiving inputs from sensors 104 and/or receive sensor data from the takeoff and landing area 200 to locate the aircraft.

The computing system may then analyze the data using one or more models or algorithms, including but not limited to the models or algorithms at a step 312, a step 314, a step 316, and a step 318. At the step 312, the method 300 includes calculating an aircraft state using fiducial markers. At the step 314, the method 300 includes calculating an aircraft state using visible markers. At the step 316, the method 300 includes calculating an aircraft state using infrared beacons. And at the step 318, the method 300 includes calculating an aircraft state using LiDAR/34D points cloud association. The computing system may select one or more models or algorithms to carry out, perhaps based on the data that is being collected to determine weighted coefficients given to data. The computing system may determine the weighted coefficients using analysis methods as described above.

At the step 322, the method 300 includes receiving outputs and assigning weighted coefficients to each output. For example, the computing device may compare successive LiDAR sensor outputs and determine that the LiDAR sensor outputs are relatively stable. Whereas, the computing system may compare successive sensor outputs of various visible markers in the environment and determine that the sensor data varies from sensor output to sensor output. Therefore, the computing system may determine that data from the LiDAR data is more reliable than sensor data of the visible markers. And the computing system may assign weighted coefficients based on this output, perhaps assigning a higher weighted coefficient of the LiDAR sensor output and a lower weighted coefficient to the sensor data of the visible markers.

At the step 324, the method 300 includes estimating or inferring an aircraft state of aircraft relative to the landing area based on weighted coefficients. For example, if the LiDAR sensor data indicates that the aircraft is moving at 180 degrees south, the sensor data of the markers indicates that the aircraft is moving at 135 degrees south east, and the LiDAR sensor data is weighted at twice the weight of the sensor data of the visible markers, then the computing system may determine that the aircraft is going at 165 degrees south east. The aircraft may then navigate in the environment based on this determination, perhaps by adjusting its aircraft state to fly more directly towards the takeoff and landing area. In some examples, estimating or inferring an aircraft state may include estimating a 3D position, velocity, altitude, and/or orientation values, perhaps as a vector of states.

As mentioned above, one issue that may arise in a system where an aircraft approaches a takeoff and landing area is that one or more markers on the takeoff and landing system are not visible to the aircraft, thereby potentially causing issues with the aircraft landing safely. To help facilitate landing, the takeoff and landing area as described herein may incorporate a fiducial marker system by way of a display.

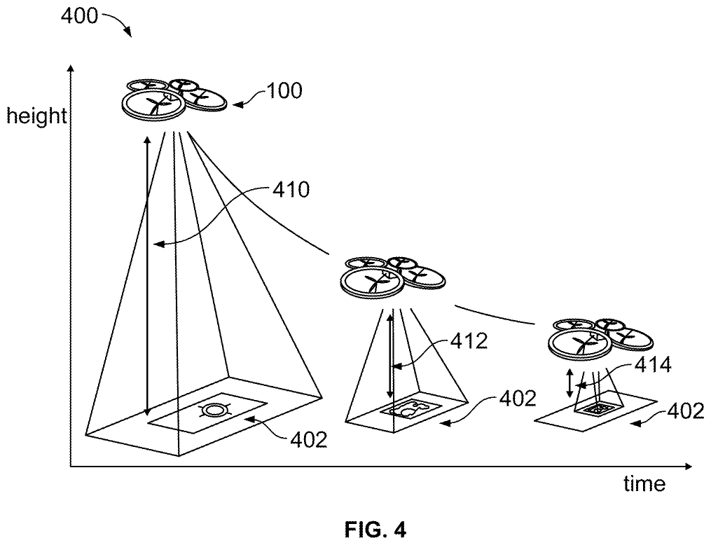

FIG. 4 illustrates a fiducial marker system, in accordance with exemplary embodiments of the present invention. In particular, as the aircraft 100 approaches a fiducial marker 402, the fiducial marker changes its display so that it may be visible and distinguishable at each height. For example, a plot 400 illustrates the fiducial marker system as the aircraft 100 approaches the fiducial marker. At a height 410, the fiducial marker 402 may display a symbol recognizable from a height 410. At a height 412, the fiducial marker 402 may display a symbol recognizable from a height 412. And at a height 414, the fiducial marker 402 may display a symbol recognizable from a height 414.

To determine which symbol to display, the aircraft 100 may periodically send a signal to the takeoff and landing area that contains the fiducial marker 402. The signal may indicate the height of the aircraft 100 at the moment that the aircraft captures the sensor data. Additionally and/or alternatively, the aircraft 100 may send the data and the takeoff and landing system may determine the height of the aircraft 100. The computing system of the takeoff and landing system may update fiducial marker 402 based on the determined and/or received height of the aircraft 100.

Additionally and/or alternatively, the takeoff and landing area may contain a fiducial marker of the vertiport identification symbol provided by the Federal Aviation Association. The symbol may have dimensions of 10 feet by 10 feet and may consist of a circle surrounded by four T shapes equidistant from each other.

Additionally and/or alternatively, the computing system may also implement a perception-based navigation (PBN) system. Two dimensions to redundancy are availability and reliability and a redundant navigation system may implement both availability and reliability. One way to achieve this is by using multi-modal sensor technology with different error characteristics. An example of such solution is a Perception-Based Navigation system which combines a set of cameras (VIS or NWIR/LWIR) with a mmWave radar. These dissimilar sensors complement each other to provide a more robust hybrid solution. Namely, the visible/IR camera may have the advantage of high angular resolution (pixels per degree) and potential to use color/heat to differentiate features. However, the camera navigation aid may not be available at longer ranges, especially in degraded visibility. In contrast, while the mmW radar may have lower angular resolution, it includes range information and provides better visibility in degraded visible environments such as fog or smog. Combining these sensors delivers a solution that addresses the low-altitude approach and landing phases, with availability in degraded visibility and increasing accuracy closer to the landing site.

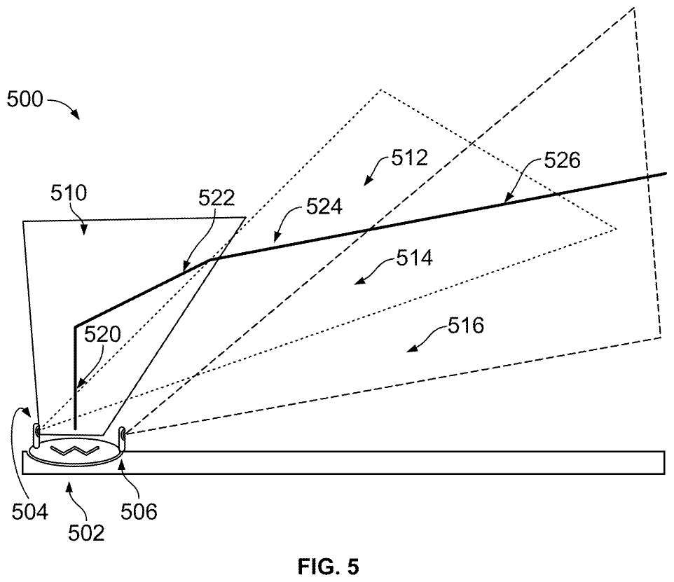

The technology described above for PBN during low-altitude approach and landing may also be useful for takeoff and low-altitude departure. Takeoff/departure phases are similar to approach/landing phases except in the takeoff/departure phases, the takeoff and landing area identifier and initial position are known, and also the widening of the obstacle clearance volume over time allows for longer use of coasting. Additional hybridization/monitoring would likely be performed using available non-perception based navigation aids, such as RTK/PPP GNSS, and barometer/radar altimeter. High altitude approach nav-aids, such as (SBAS) GNSS and INS, that deliver the vehicle to the low altitude approach may be cross-checked with PBN in transition between flight phases. FIG. 5 illustrates sensor fields of view, in accordance with exemplary embodiments of the present invention. FIG. 5 depicts a visual beacon 504 and a pulsed RF reflector 506, both of which may be located on a takeoff and landing area 502. An aircraft approaching the takeoff and landing area 502 may follow an approach/departure path stage 1 526, an approach/departure path stage 2 524, an approach/departure path stage 3 526, and a vertical landing path 520. When the aircraft is following the approach/departure path stage 1 526 and/or the approach/departure path stage 2 524, the aircraft may be detectable in the regions of the pulsed RF reflector region 516 as well as the visual beacon region. And when the aircraft is following the approach/departure path stage 3 522 and/or vertical landing path 520, the aircraft may be visible within the visual fiducial region 510. In some examples, the preferred approach and departure path of the aircraft may be based on the predominant wind direction. Thus, the configuration of the sensors may be based on the predominant wind direction to account for the preferred approach and departure path of the aircraft.

There may be overlapping regions of navigation technology as the aircraft approaches or departs the takeoff and landing area. These regions reflect both the sensor operating range and the operating envelope for approach and landing. At longer ranges, the mmW radar may provide range and a line-of-sight direction measurement with good weather penetration, but lower angular accuracy. Within visible ranges, a visual beacon may provide a direction measurement with better angular accuracy. Finally, when multiple fiducials are visible, an accurate six degree-of-freedom (6 DOF) navigation solution may be computed. The main requirement for each region is to ensure sufficient obstacle clearance and to deliver the aircraft to the next region. The new navigation aid available in the next region allows the system to meet increasingly stringent accuracy/integrity requirements.

In ILS, infrastructure inspection/monitoring may ensure acceptable performance of the navigation aids. Takeoff and landing area infrastructure may include some form of monitoring, which may be lower cost and maintenance effort than an ILS to enable scaling to multiple takeoff and landing areas. The proposed navigation aiding infrastructure may provide a reliable method to detect and identify features placed near the takeoff and landing area, while supporting accuracy/integrity over the approach and provide an efficient infrastructure monitoring system.

Each primary navigation solution may be designed to provide the accuracy, integrity, and availability within that phase before entering the next region. In cases where multiple navigation solutions are available, the redundant navigation data may be used for primary navigation monitoring and as a backup navigation source.

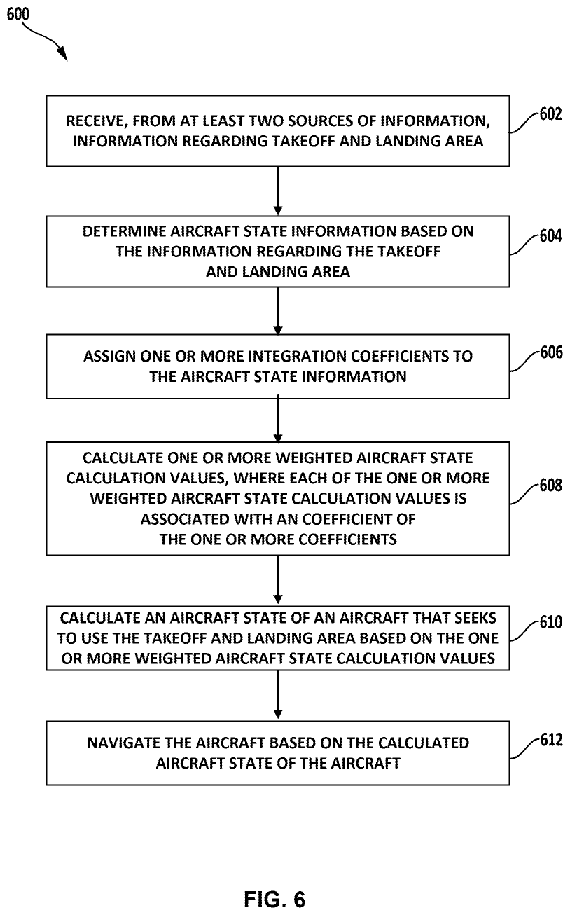

FIG. 6 is a flowchart of a method, in accordance with exemplary embodiments of the present invention. A method 600 may be carried out by a computing system. For example, the method 600 may be carried out by the computing system 102 of the aircraft 100 of FIG. 1 and/or the computing system 202 of takeoff and landing area 200 of FIG. 2. In some examples, the method 600 may be carried out by one or more computing systems. For example, the aircraft 100 may carry out one or more of the steps of the method 600, and takeoff and landing area may carry out the other steps. In some examples, a system may include a takeoff and landing area comprising at least two sensors, each sensor configured to provide a sensor output containing information regarding a takeoff and landing area, and an aircraft comprising a computing system, the computing system configured to carry out the steps of method 600. In further examples, an aircraft may include at least one antenna configured to receive information regarding a takeoff and landing area from one or more sensors and a computing system configured to carry out the steps of method 600.

At a step 602, the method 600 includes receiving, from the at least two sensors on an aircraft, sensor output containing information regarding the takeoff and landing area.

At a step 604, the method 600 includes receiving aircraft state information based on the sensor output containing information regarding the takeoff and landing area.

At a step 606, the method 600 includes assigning one or more coefficients to the aircraft state information.

At a step 608, the method 600 includes calculating one or more weighted aircraft state calculation values, wherein each of the one or more weighted aircraft state calculation values is associated with a coefficient of the one or more coefficients.

At a step 610, the method 600 includes calculating an aircraft state of an aircraft that seeks to use the takeoff and landing area based on the one or more weighted aircraft state calculation values.

At a step 612, the method 600 includes navigating the aircraft based on the calculated aircraft state of the aircraft.

In some examples, the aircraft state information may be orientation information of the aircraft and/or position information of the aircraft.

In some examples, the one or more weighted aircraft state calculation values may be one or more weighted orientation calculation values and/or one or more weighted position calculation values.

In some examples, the calculated aircraft state of the aircraft may be a calculated orientation of the aircraft and/or a calculated position of the aircraft.

In some examples, the takeoff and landing area for the aircraft may further include at least one display comprising a dynamic fiducial marker configured to change display from a first symbol to a second symbol after the aircraft reaches a threshold distance from the takeoff and landing area.

In some examples, the at least one display comprises smart paint or a screen to display the dynamic fiducial marker.

In some examples, the takeoff and landing area may further include at least one display module comprising a dynamic fiducial marker and an optical coating, where the optical coating enables the dynamic fiducial marker to be visible in a visible light spectrum to a long wave infrared spectrum.

In some examples, the takeoff and landing area may further include a plurality of light sources arranged in a predefined pattern.

In some examples, the aircraft may be a vertical takeoff and landing aircraft.

In some examples, the vertical takeoff and landing aircraft may be an electrical vertical takeoff and landing aircraft.

In some examples, the takeoff and landing area comprises at least two markers, and where calculating aircraft state information is based on the at least two markers.

In some examples, the takeoff and landing area comprises at least one radar reflector, and where calculating the aircraft state information is based on calculating a radar cross section of the aircraft.

In some examples, the at least one radar reflector is a multiple scatterer radar reflector, a dielectric lens radar reflector, or a retrodirective array radar reflector.

In some examples, the at least one radar reflector is a square trihedral corner reflector, a triangular trihedral corner reflector, or a circular trihedral corner reflector.

In some examples, the takeoff and landing area further comprises a transmitter configured to transmit a signal to be deflected from the aircraft to detect a position or aircraft state of the aircraft, where the at least two sensors is configured to provide the sensor output by detecting the signal after the signal has been deflected by the aircraft.

In some examples, the one or more coefficients are based on a flight stage of the aircraft.

In some examples, the takeoff and landing area further comprises at least one anchor node configured to receive a data request by an aircraft, where calculating the aircraft state information is based on round-trip time of flight and direction-of-arrival measurement methods.

In some examples, the takeoff and landing area further comprises a plurality of anchor nodes each configured to receive a data request by an aircraft, where each anchor node communicates with each other through time-division multiple access, and where calculating the aircraft state information is based on response time of the anchor nodes to the data request by the aircraft.

In some examples, at least one sensor of the at least two sensors is a receiver configured to receive an angle of arrival based on a signal transmitted by the takeoff and landing area.

In some examples, at least one sensor of the at least two sensors is configured to receive a signal, where the computing system is further configured to determine a confidence measurement of the at least two sensors based on a frequency of the received signal, an aircraft antenna size, or an environment type.

In some examples, the environment type is a low multipath environment, where the confidence measurement is a high confidence measurement.

In some examples, the aircraft further comprises at least one antenna, where the antenna is a directional antenna or a configurable reception pattern antenna.

In some examples, the aircraft further includes a communication module configured to request and receive an environment map.

In some examples, the environment map comprises a 3-dimensional LiDAR building data, where at least one sensor of the at least two sensors is a LiDAR sensor, and where the computing system is further configured to compare the 3-dimensional LiDAR building data with sensor output from the LiDAR sensor.

In some examples, at least one sensor of the at least two sensors is a LiDAR sensor, where the computing system is further configured to receive a first sensor output from the LiDAR sensor and consecutively, a second sensor output from the LiDAR sensor, and where the computing system is configured to compare the first sensor output and the second sensor output to output the weighted aircraft state calculation values.

In some examples, comparing the first sensor output and the second sensor output is based on applying an iterative closest point algorithm.

In some examples, at least one sensor of the at least two sensors is a LiDAR sensor, where the computing system is further configured to extract one or more recognizable features from the sensor output of the LiDAR sensor based on an M-estimator sample consensus algorithm.

In some examples, the at least two sensors comprise a first sensor and a second sensor, where the first sensor is a visible light camera, near infrared camera, or a long wave infrared camera, and where the second sensor is a millimeter wave radar sensor.

In some examples, a takeoff and landing area may comprise a first sensor configured to provide a first sensor output containing information regarding the takeoff and landing area, a second sensor configured to provide a second sensor output containing information regarding the takeoff and landing area, and a transceiver configured to transmit the first and second sensor outputs to an aircraft seeking to utilize the takeoff and landing area, where the aircraft is configured to receive the first and second sensor outputs. The aircraft may further be configured to determine aircraft state information based on the first and second sensor outputs. The aircraft may additionally be configured to assign one or more coefficients to the aircraft state information. The aircraft may further be configured to calculate one or more weighted aircraft state calculation values, where each of the one or more weighted aircraft state calculation values is associated with a coefficient of the one or more coefficients. The aircraft may additionally be configured to calculate an aircraft state of the aircraft based on the one or more weighted aircraft state calculation values. The aircraft may also be configured to navigate the aircraft based on the calculated aircraft state of the aircraft.

The methods described herein may include further additional steps as described throughout herein.

The detailed description above describes various features and operations of the disclosed systems with reference to the accompanying figures. The illustrative implementations described herein are not meant to be limiting. Certain aspects of the disclosed systems can be arranged and combined in a wide variety of different configurations, all of which are contemplated herein.

Further, unless context suggests otherwise, the features illustrated in each of the figures may be used in combination with one another. Thus, the figures should be generally viewed as component aspects of one or more overall implementations, with the understanding that not all illustrated features are necessary for each implementation.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, devices or systems may be used or configured to perform functions presented in the figures. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner.

By the term “substantially” or “about” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

The arrangements described herein are for purposes of example only. As such, those skilled in the art will appreciate that other arrangements and other elements (e.g., machines, interfaces, operations, orders, and groupings of operations, etc.) can be used instead, and some elements may be omitted altogether according to the desired results. Further, many of the elements that are described are functional entities that may be implemented as discrete or distributed components or in conjunction with other components, in any suitable combination and location.

While various aspects and implementations have been disclosed herein, other aspects and implementations will be apparent to those skilled in the art. The various aspects and implementations disclosed herein are for purposes of illustration and are not intended to be limiting, with the true scope being indicated by the following claims, along with the full scope of equivalents to which such claims are entitled. Also, the terminology used herein is for the purpose of describing particular implementations only, and is not intended to be limiting.

1. A system comprising:
a takeoff and landing area comprising at least two sources of information, each of the sources of information being configured to provide information regarding the takeoff and landing area; and
an aircraft comprising a computing system, the computing system configured to:
receive, from the at least two sources of information, information regarding the takeoff and landing area;
determine aircraft state information based on the information regarding the takeoff and landing area;
assign one or more coefficients to the aircraft state information;
calculate one or more weighted aircraft state calculation values, wherein each of the one or more weighted aircraft state calculation values is associated with a coefficient of the one or more coefficients;
calculate an aircraft state of an aircraft that seeks to use the takeoff and landing area based on the one or more weighted aircraft state calculation values; and
navigate the aircraft based on the aircraft state of the aircraft.

2. The system of claim 1, wherein the at least two sources of information comprise:
at least one display comprising a dynamic fiducial marker configured to change display from a first symbol to a second symbol after the aircraft reaches a threshold distance from the takeoff and landing area.

3. (canceled)

4. The system of claim 1, wherein the at least two sources of information comprise at least one display module comprising a dynamic fiducial marker and an optical coating, wherein the optical coating enables the dynamic fiducial marker to be visible in a visible light spectrum to a long wave infrared spectrum.

5-7. (canceled)

8. The system of claim 1, wherein the takeoff and landing area comprises at least two markers, and wherein calculating aircraft state information is based on the at least two markers.

9. The system of claim 1, wherein the takeoff and landing area comprises at least one radar reflector, and wherein calculate the aircraft state information is based on calculating a radar cross section of the aircraft.

10-11. (canceled)

12. The system of claim 1, wherein the at least two sources of information comprise a transmitter configured to transmit a signal to be deflected from the aircraft to detect a position or orientation of the aircraft, and wherein the at least two sources of information is configured to provide the information by detecting the signal after the signal has been deflected by the aircraft.

13. The system of claim 1, wherein the one or more coefficients are based on a flight stage of the aircraft.

14. The system of claim 1, wherein the at least two sources of information comprise at least one anchor node configured to receive a data request by the aircraft, wherein calculating the aircraft state information is based on round-trip time of flight and direction-of-arrival measurement methods.

15. The system of claim 1, wherein the at least two sources of information comprise a plurality of anchor nodes each configured to receive a data request by the aircraft, wherein each anchor node communicates with each other through time-division multiple access, and wherein calculating the aircraft state information is based on response time of the anchor nodes to the data request by the aircraft.

16. A method comprising:
receiving, from at least two sources of information, information regarding a takeoff and landing area;
determining aircraft state information based on the information regarding the takeoff and landing area;
assigning one or more coefficients to the aircraft state information;
calculating one or more weighted aircraft state calculation values, wherein each of the one or more weighted aircraft state calculation values is associated with a coefficient of the one or more coefficients;
calculating an aircraft state of an aircraft that seeks to use the takeoff and landing area based on the one or more weighted aircraft state calculation values; and
navigating the aircraft based on the aircraft state of the aircraft.

17. The method of claim 16, wherein the at least two sources of information are on the aircraft.

18-32. (canceled)

33. An aircraft comprising:
at least one antenna configured to receive information regarding a takeoff and landing area from one or more sources of information;
a computing system configured to:
receive, from at least two sources of information, information regarding the takeoff and landing area;
determine aircraft state information based on the information regarding the takeoff and landing area;
assign one or more coefficients to the aircraft state information;
calculate one or more weighted aircraft state calculation values, wherein each of the one or more weighted aircraft state calculation values is associated with a coefficient of the one or more coefficients;
calculate an aircraft state of the aircraft based on the one or more weighted aircraft state calculation values; and
navigate the aircraft based on the aircraft state of the aircraft.

34. The aircraft of claim 33, wherein the at least two sources of information comprise a receiver configured to receive an angle of arrival based on a signal transmitted by the takeoff and landing area.

35. The aircraft of claim 33, wherein the at least two sources of information is configured to receive a signal, and wherein the computing system is further configured to determine a confidence measurement of the at least two sources of information based on a frequency of the signal, an aircraft antenna size, or an environment type.

36. (canceled)

37. The aircraft of claim 33, wherein the aircraft further comprises at least one antenna, and wherein the antenna is a directional antenna or a configurable reception pattern antenna.

38. (canceled)

39. The aircraft of claim 33, wherein the aircraft further comprises a communication module configured to request and receive an environment map, wherein the environment map comprises a 3-dimensional LiDAR building data, wherein the at least two sources of information comprises a LiDAR sensor, and wherein the computing system is further configured to compare the 3-dimensional LiDAR building data with sensor output from the LiDAR sensor.

40. The aircraft of claim 33, wherein the at least two sources of information comprises a LiDAR sensor, wherein the computing system is further configured to receive a first sensor output from the LiDAR sensor and consecutively, a second sensor output from the LiDAR sensor, and wherein the computing system is configured to compare the first sensor output and the second sensor output to output the weighted aircraft state calculation values.

41. The aircraft of claim 40, wherein comparing the first sensor output and the second sensor output is based on applying an iterative closest point algorithm.

42. The aircraft of claim 33, wherein the at least two sources of information comprises a LiDAR sensor, and wherein the computing system is further configured to extract one or more recognizable features from an output of the LiDAR sensor based on an M-estimator sample consensus algorithm.

43. The aircraft of claim 33, wherein the at least two sources of information comprise a first sensor and a second sensor, wherein the first sensor is a visible light camera, near infrared camera, or a long wave infrared camera, and wherein the second sensor is a millimeter wave radar sensor.

44. (canceled)
